(19) United States
(12) Patent Application Publication
(10) Pub. No.: US 2015/0084358 A1
(43) Pub. Date: Mar. 26, 2015

(54) Expandable Chassis

(71) Applicant: Robert Frost, LaGrange, IN (US)

(72) Inventor: Robert Frost, LaGrange, IN (US)

(21) Appl. No.: 14/038,198

(22) Filed: Sep. 26, 2013

(51) Int. Cl. B62D 21/14

(52) U.S. Cl. CPC B62D 21/14
USPC 296/26.13

(57) ABSTRACT

An expandable vehicle chassis, said chassis comprising: a frame; at least two opposing support arms movably attached to said frame; a drive shaft attached to said frame and operably attached to each of said at least two opposing support arms; an actuator mechanically attached to said drive shaft; and a plurality of gear mechanisms generally disposed along an axis parallel to said drive shaft, said gear mechanisms operably attached to said drive shaft such that said actuator engages said drive shaft and said drive shaft engages said gear mechanisms to simultaneously move apart said at least two support arms in opposing directions.

### BACKGROUND

1. Field of the Art

The present invention relates generally to chassis for vehicles, especially land vehicles. More specifically, the present invention relates to selectively expandable chassis for land vehicles, such as recreational vehicles (“RVs”) and large truck trailers.

2. Description of the Prior Art

U.S. Pat. No. 2,704,223 (the “'223 patent”), entitled, Operating Mechanism for Telescopic Bodies for Vehicles, was filed on Feb. 27, 1951 and expired on Mar. 15, 1972. The '233 patent generally discloses a vehicle body comprising a chassis housing a fixed portion and a movable portion whereby the moveable portion allows for expansion of the vehicle body.

U.S. Pat. No. 3,169,280 (the “'280 patent”), entitled, Expansible House Trailer, was filed on Dec. 30, 1960 and expired on Feb. 16, 1982. The '280 patent generally discloses a house trailer having telescoping sections.

U.S. Pat. No. 4,930,837 (the “'837 patent”), entitled, Camping Conversion, was filed on Jun. 14, 1988 and expired on Jun. 14, 2007. The '837 patent generally discloses a camping conversion for motor vehicles having an open interior compartment. The conversion includes a floor panel supported by tracks and retractable beneath the vehicle floor and an auxiliary pop-out compartment that protrudes from the side of the vehicle and is retractable into the vehicle interior. In the extended position, the auxiliary pop-out compartment rests on the extended floor panel. The auxiliary pop-out compartment has telescoping sidewalls which overlap one another when retracted to save interior space.

U.S. Pat. No. 5,154,469 (the “'469 patent”), entitled, Mobile, Multiuse, Expandable Rooms, was filed on Jun. 26, 1991 and expired on Jun. 26, 2011. The '469 patent generally discloses a vehicle comprising a towable wheeled undercarriage upon which is mounted a unit having four independent rooms, each of which is collapsed for towing and which can be greatly extended in volume both horizontally and vertically for use. The four rooms have a common corner at the center of the unit. Each room includes a slide out section slidable beyond the sides of the undercarriage and an inner section that is attached to the floor. The slide out sections can be extended simultaneously until their roofs lock to a main roof over the fixed inner room sections. All roofs and their attached, telescoped, upper room walls can be raised simultaneously by a single drive device, such as a hydraulic cylinder, at the center of the main roof at the common corner of the rooms. With the rooms extended and the vertically extending rooms telescoped up, four large, private, independent, solid-walled, rooms with separate exterior doors are created. The undercarriage is mounted on four wheels on two axles. The forward axle is longer than the rear axle so that the wheels can be nested together to provide improved stability and ease of towing.

U.S. Pat. No. 5,491,933 (the “'933 patent”), entitled, Flat Floor Slide Out Apparatus for Expandable Rooms, was filed on Sep. 20, 1994 and expires on Sep. 20, 2014. The '933 patent generally discloses an expandable room structure for a recreational vehicle or trailer having relatively movable room portions supported by telescopically sliding tubes, at least one of those tubes being movable also laterally to pivot as the room portion floors slide into the same horizontal plane when the room structure is moving into expanded positions. In retracted positions, the room portion floors are vertically spaced to permit one room portion to nest within the other. A rack and pinion drive arrangement is provided to cause relative movement between the tubes. Lateral movement of one of the tubes is permitted by engagement with an inclined surface extending out of the other tube such that the laterally moving tube pivots about the pinion. A ramp surface is formed on the abutting edge of the floor of one room portion, and the abutting edge of the floor of the other room portion moves up and down that ramp portion when transitioning between expanded and retracted positions.

U.S. Pat. No. 5,628,541 (the “541 patent”), entitled, Expandable Coach Having at Least One Expansion Chamber, was filed on Jan. 19, 1995 and expires on Jan. 19, 2015. The '541 patent generally discloses a coach, having an interior living space, which coach has at least one and no more than two expansion chambers. Each expansion chamber is formed as a box having top, side and bottom walls and one rear or front wall. The coach may be a trailer, an RV body disposed upon a truck chassis, or a recreational vehicle having a self-contained propulsion system. The coach may have instead of wheels as a support system, a series of vertical jacks or other support mechanisms to thereby render the coach suitable for use as an office or an industrial facility. The coach features a spaced inner and outer wall construction. The chamber is adapted such that its sidewalls, when in the retracted position, are disposed between the inner and outer sidewalls of the living space. The expansion chamber sidewalls move from their respective first stowed inner disposition between the inner and outer wall rearwardly or forwardly depending upon the disposition of the expansion chamber to a second outer expanded position, and the top and bottom walls move from a stowed disposition beneath the top wall and beneath the floor of the living space respectively to a second outer expanded position. For support of the expanded chamber, a pair of deployable rails are moved from a stowed position to an in-use position, cantilevered from beneath the body of the living space to support the expansion chamber.

U.S. Pat. No. 5,833,296 (the “'296 patent”), entitled, Motor-operated Slide-Out Drive System with Releasable Brake, was filed on Feb. 4, 1997 and expires on Feb. 4, 2017. The '296 patent generally discloses an operating mechanism for an expandable vehicle slide-out section for a recreational vehicle the mechanism includes a pair of inner rail members, each being slidably supported in an outer rail member secured to the vehicle body. Each of the inner rail members has an outer end attachable to the slide-out section. A power drive arrangement includes a drive shaft operably connected with the inner rail members to synchronize travel of each of the inner rail members. The power drive arrangement includes an integral motor-brake having a conveniently accessible release mechanism for selectively releasing engagement of the brake with the drive shaft. A manual override system is adjustably mounted on the drive shaft to extend and retract the slide-out section when the brake is released, should the power drive arrangement become inoperable.

U.S. Pat. No. 5,857,733 (the “'733 patent”), entitled, Synchronization Device for a Slide Out Room, was filed on Jan. 14, 1997 and expires on Jan. 14, 2019. The '733 patent generally discloses a synchronization device for use on recreational vehicles having slide out rooms that keeps the slide out room properly aligned with the frame of the recreational vehicle in order to ensure smooth operation. The device of the present invention includes a pair of elongated extensible members that connect the moveable frame to the fixed frame. Each of the members includes an inner end pivotally mounted to the fixed frame and an outer end pivotally mounted to the moveable frame, with the extensible members being shiftable between a folded, shortened position and an unfolded, extended position as the slide out room is extended. Each extensible member includes a hollow outer leg an extensible inner leg that is telescopically disposed within the outer leg. A pinion interconnects the extensible members and synchronizes the extension and retraction of the inner legs relative to the outer legs, and also synchronizes the folding or unfolding of the extensible members. Thus, the moveable frame remains parallel to and aligned with the fixed frame at all times.

U.S. Pat. No. 6,234,566 (the “'566 patent”), entitled, Drive System for Extendable Rooms on Recreational Vehicles, was filed on Jul. 20, 1999 and expires on Jul. 20, 2019. The '566 patent generally discloses a synchronized rack and pinion system for extendable rooms for recreational vehicles. In particular, the invention provides a drive system for use in extending and retracting an extendable room on a vehicle frame. The drive system includes at least one pair of parallel rack and pinion systems operatively connected between the vehicle frame and the extendable room, with each pair of parallel rack and pinion systems synchronized through respective drive shafts. The system is operable between a closed position where the extendable room is retracted with respect to the vehicle frame and an open position where the extendable room is extended with respect to the vehicle frame.

U.S. Pat. No. 6,299,229 (the “'229 patent”), entitled, Mobile Morgue, was filed on Apr. 26, 2000 and expires on Apr. 26, 2020. The '229 patent generally discloses a mobile mortuary in which a semi-trailer has extendable large side walls. The inside of the semi-trailer which constitutes a mobile unit is divided into three compartments, one a cooled end cabin, independent of the other two, with a side access door, for emplacement of the casket, which is visible through an inside end window, and the other two compartments define the zone in which the body has extendable facing side walls. One of these compartments can be accessed via the rear end of the unit by a staircase and a ramp, both of which can be folded up into the structure or chassis. Motors are installed in the semi-trailer chassis structure to drive a rack and pinion mechanism. Each rack is mounted on the moving part of the side wall, and the side walls are guided in their displacement by upper and lower guides with rollers which move along facing guides in the stationary portion of the body.

U.S. Pat. No. 6,338,523 (the “'523 patent”), entitled, Sliding Mechanisms and Systems, was filed on Nov. 23, 1999 and expired on Nov. 23, 2019. The '523 patent generally discloses a sliding mechanism for extending and retracting a slide-out compartment comprising a guide member having two securing flanges separated by a gap that communicates with an interior channel. A slider rail is disposed within the interior channel and has a middle portion adapted with a plurality of holes formed therein. Extending from the middle portion are two securing members that cooperate with the securing flanges of the guide member to maintain slider rail within the interior channel as middle portion extends into the gap. Disposed within the interior channel at one end of the guide element is a gear mechanism. The gear mechanism includes a gear shaft and a gear attached to the gear shaft. The gear mechanism drivingly engages a plurality of teeth on the gear within the plurality of holes in the middle portion of the slider rail to extend or retract the slide-out compartment. A timing assembly is attached to the gear shaft to allow two or more gear shafts to be timed relative to one another. Attached to the second end of the gear shaft is a manual activation assembly, such as a hand crank. Alternatively, a motorized activation assembly may be attached to gear shaft. One embodiment of the motorized activation assembly includes a quick-release arrangement that allows a motor to be quickly and easily released from the gear shaft or a motorized activation assembly.

U.S. Pat. No. 6,428,073 (the “'073 patent”), entitled, Vehicle with Slide-out Room, was filed on Nov. 27, 2000 and expired on Nov. 27, 2020. The '073 patent generally discloses a vehicle having a fixed room and a slide-out room which extends and retracts relative to the fixed room. The fixed room includes a floor section, sidewall sections, and a roof section, and the slide-out room includes a floor section, sidewall sections, and a roof section. A slide-out extension mechanism extends and retracts the slide-out room in a cantilevered manner. In a fully retracted position, the roof section and two of the sidewall sections of the slide-out room are typically concealed from exterior view, and a third sidewall section of the slide-out room forms a portion of the sidewall section of the fixed room. Furthermore, the floor section of the slide-out room is flush with the floor section of the fixed room, and proximal ends of the sidewall sections of the slide-out room are flush with an inner surface of one of the sidewall sections of the fixed room when the slide-out room is fully extended. The slide-out extension mechanism includes a first elongated member which is secured to the fixed room and a second elongated member which is slidingly coupled to the first elongated member. The second elongated member is secured to the slide-out room such that extension and retraction of the second elongated member causes the slide-out room to similarly extend and retract. In order to preferentially strengthen the second elongated tube in the z direction, the second elongated tube includes a first tube secured to a second tube.

U.S. Pat. No. 6,729,677 (the “'677 patent”), entitled, Full Body Slide and Integrated Chassis, was filed on Feb. 19, 2003 and expired on Feb. 19, 2023. The '677 patent generally discloses a full body slide out room assembly is for a vehicle with stationary end modules, a stationary roof and a plurality of moveable room assemblies that consist of a telescoping roof, floor, anterior walls, and end walls. The sliding movement of each room is controlled by one or more linear drive mechanisms that are pneumatic, hydraulic, mechanical, electro-mechanical, or combination of two or more of these methods. Each moveable room is supported by a center or offset longitudinal truss or trusses below the floor level, and a plurality of guide rails and support rails located between the vehicle chassis and the moveable room. Polymer plates are installed between the support and guide rails.

U.S. Pat. No. 6,796,590 (the “'590 patent”), entitled, In floor Slide-out Room Support System, was filed on Nov. 19, 2002 and expired on Nov. 19, 2022. The '590 patent generally discloses a slide-out room support system for a recreational vehicle having C-shaped rails received at least partially within the thickness of the floor with the slot of the C-shape opening downwardly. A fixed support extends up through the slot and mounts four rollers, two on each side, which extend into the space between the top wall of the rail and the flanges so as to support the rail generally horizontal and relieve much of the weight of the slide-out room from being borne by the stationary floor of the recreational vehicle. A lead screw that moves longitudinally with the rail drives it in and out, and a rack and pinion system synchronizes the movement of the rails when two or more rails are provided. The lead screw, or alternatively the rack and pinion system, may be manually or electrically driven.

U.S. Pat. No. 6,981,728 (the “'728 patent”), entitled, was filed on Dec. 2, 2002 and expires on Dec. 2, 2022. The '728 patent generally discloses a system is described which may be used to extend and retract a slide-out compartment of a vehicle.

U.S. Pat. No. 7,229,123 (the “'123 patent”), entitled, Camper Slide-out System, was filed on Apr. 22, 2005 and expires on Apr. 22, 2025. The '123 patent generally discloses a slide-out system for a recreational vehicle having a slide block that is form fit with a sliding connection to a track so as to vertically and laterally support a slide-out room relative to the stationary portion of the vehicle. The room is driven in and out by a rack and pinion drive and a synchronizing screw is provided at least one end of the drive shaft so that two spaced apart slide-out units can be synchronized relative to one another and to ease disassembly of the shafts and motor drive unit.

U.S. Pat. No. 7,234,747 (the “'747 patent”), entitled, Sliding Mechanisms and Systems, was filed on Apr. 22, 2005 and expires on Apr. 22, 2025. The '747 patent generally discloses a sliding mechanism for moving a slide-out compartment of a vehicle. The mechanism includes a guide member, a sliding member, and a gear. The gear is used to move the sliding member relative to the guide member. The sliding member and the guide member cooperate with each other to move the slide-out compartment between an extended position and a retracted position.

U.S. Pat. No. 7,300,086 (the “'086 patent”), entitled, Slide Out for a Motor Home, was filed on Jun. 1, 2005 and expires on Jun. 1, 2025. The '086 patent generally discloses a vehicle that is a motor home having a slide out body member that extends across an opening in the side wall of the vehicle body is disclosed. The slide out body member is capable of movement between a laterally expanded position during recreational use of the vehicle and a refracted position for travel of the vehicle on roads. The slide out body member has a primary wall portion covering at least a portion of the side wall of the vehicle body and end walls at each end of the primary wall portion extending back towards the vehicle body. The slide out body member also has a top and a bottom extending from the upper and lower edges of the primary wall portion back towards the vehicle body so that the space defined by the slide out body member opens into and forms part of the interior space of the vehicle body. The vehicle also includes a service connector in the form of a flexible conduit extending between the vehicle body and the associated service fittings in the vehicle slide out. It also includes a conduit organizer for guiding the flexible conduit to fold up and then unfold when the slide out body member is moved between the expanded and refracted positions.

U.S. Pat. No. 7,712,813 (the “'813 patent”), entitled, Expandable Trailer, was filed on Aug. 1, 2006 and expires on Aug. 1, 2026. The '813 patent generally discloses an expandable trailer comprising a chassis, at least one pair of extendable supports, at least one pair of horizontal floor sections and at least one pair of floor elements. Each support is extendable laterally outwardly to a respective side of a central longitudinal axis of the chassis. The horizontal floor sections of each pair of horizontal floor sections are spaced apart laterally and each have an outer rail which is coupled to a corresponding one of the supports. The floor elements are pivotally coupled to each other and to the floor sections. Upon extension of the extendable supports from a retracted position to an open, extended position, the horizontal floor sections move laterally outwardly to extend from the chassis and the floor elements move from an upright vertical arrangement to an arrangement where the floor elements lie in horizontal alignment with the floor sections.

WO/2010/015062A1 (the “'062 application”), entitled, Improved Actuator for Expandable Trailer, was filed on Aug. 5, 2008, but it has not issued as a U.S. patent. The '062 application generally discloses an improved actuator mechanism for an expandable trailer is disclosed, having a rack and pinion system directly in contact with each expandable support beneath the trailer. The supports comprise an inner member free to move in and out of an outer member. The rack is fixed to the bottom outer surface of the inner member and the outer member is provided with a keyway to permit passage of the rack. A gear drive is provided at the bottom of one end of the outer member to engage the rack and thus control the extent of extension or retraction of the inner member. Preferably, the interior end of the inner member is provided with a roller to reduce frictional forces and the inner member contains a vertical fin at its outer extremity adapted to engage a slot in a planar sheet at the top of the outer member to act as an alignment guide. The inner rail rests on the fin of the inner member. The gear drive associated with each actuator on each side of the trailer is rotationally driven in synchronous fashion by a common shaft driven by a single motor. A mitre-box gear may be incorporated to simultaneously drive a pair of shafts corresponding to each side of the trailer.

Thus, the known prior art does not disclose an expandable chassis having a rack and pinion system for expansion, wherein the a plurality of pinions is aligned along a single axis, driven by a single actuator, and each pinion drives two racks simultaneously in opposing lateral directions.

### SUMMARY

In contrast to the prior art, the present invention provides a bi-laterally expandable chassis having, in one exemplary embodiment, a frame; at least two opposing support arms movably attached to said frame; a drive shaft attached to said frame and operably attached to each of said at least two opposing support arms; an actuator mechanically attached to said drive shaft; and a plurality of gear mechanisms generally disposed along an axis parallel to said drive shaft, said gear mechanisms operably attached to said drive shaft such that said actuator engages said drive shaft and said drive shaft engages said gear mechanisms to simultaneously move apart said at least two support arms in opposing directions.

### BRIEF DESCRIPTION OF THE DRAWINGS

FIG. 1 is a perspective view of a common travel trailer having an expandable vehicle chassis in accordance with an embodiment of the present invention, with the chassis in a closed position.

FIG. 2 is a perspective view of a common travel trailer having an expandable vehicle chassis in accordance with an embodiment of the present invention, with the chassis in an open position.

FIG. 3A is a top perspective view of an expandable vehicle chassis in accordance with an embodiment of the present invention, with the chassis in a closed position.

FIG. 3B is a top view of an expandable vehicle chassis in accordance with an embodiment of the present invention, with the chassis in a closed position.

FIG. 4A is a top perspective view of an expandable vehicle chassis in accordance with an embodiment of the present invention, with the chassis in an open position.

FIG. 4B is a top view of an expandable vehicle chassis in accordance with an embodiment of the present invention, with the chassis in an open position.

FIG. 5A is a top perspective view of a gear mechanism for an expandable vehicle chassis in accordance with an embodiment of the present invention.

FIG. 5B is a bottom perspective view of a gear mechanism for an expandable vehicle chassis in accordance with an embodiment of the present invention.

### DETAILED DESCRIPTION OF THE EMBODIMENTS

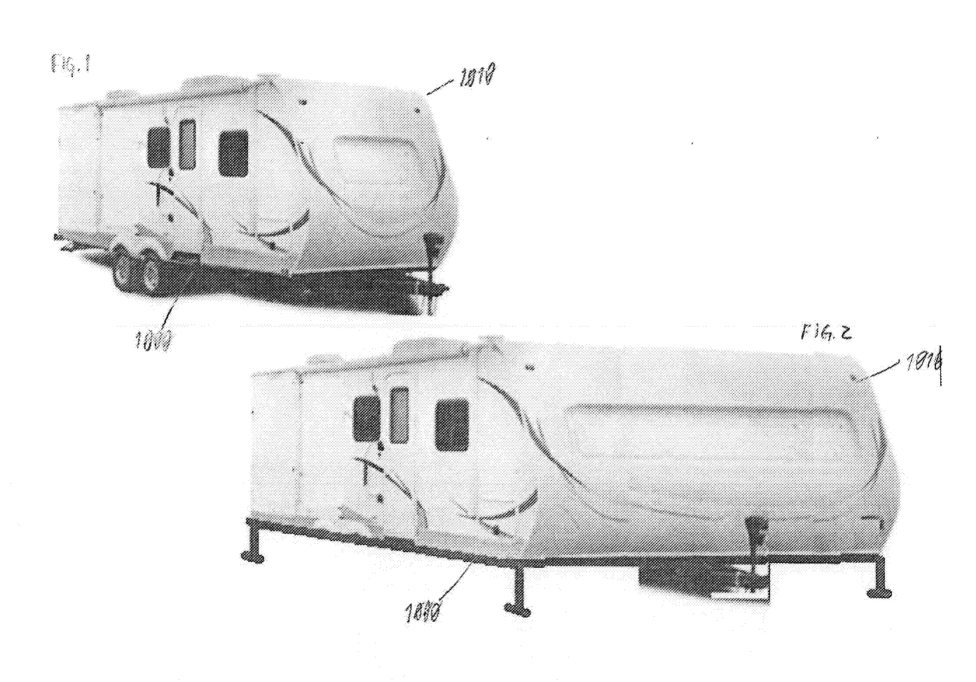

Referring first to FIG. 1, there is shown a perspective view of a common recreational trailer 1010 for a motorized road vehicle (not shown). Trailer 1010 comprises an expandable vehicle chassis 1000 in accordance with an embodiment of the present invention. As illustrated in FIG. 1, expandable vehicle chassis 1000 is in a standard non-expanded or “closed” condition.

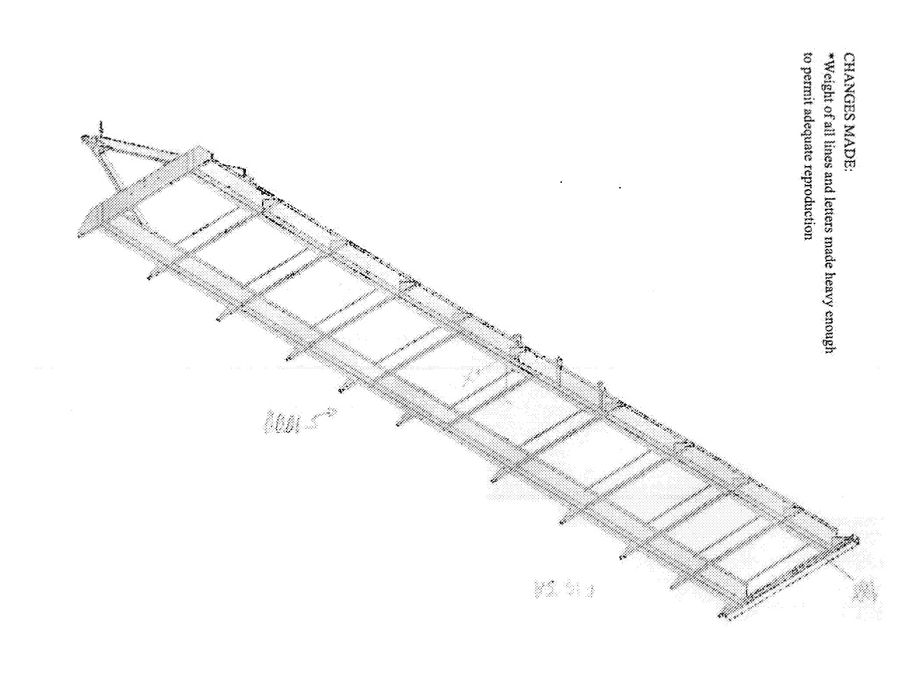

Referring next to FIG. 2, there is shown another perspective view of a common recreational trailer 1010 for a motorized road vehicle (not shown). Trailer 1010 comprises an expandable vehicle chassis 1000 in accordance with an embodiment of the present invention. As illustrated in FIG. 2, expandable vehicle chassis 1000 is in an expanded or “open” condition.

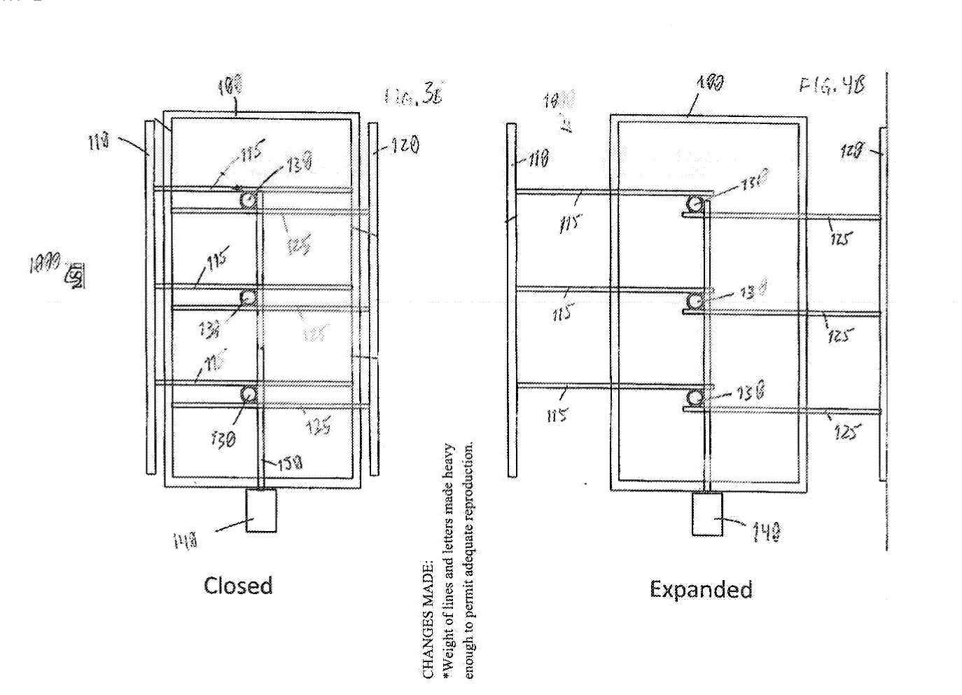

Refer now to FIG. 3A, where there is shown a top perspective view of expandable vehicle chassis 1000 in accordance with an embodiment of the present invention, with chassis 1000 in a closed position and to FIG. 3B, where there is shown a top view of expandable vehicle chassis 1000 in accordance with an embodiment of the present invention, with chassis 1000 in a closed position. Expandable vehicle chassis 1000 comprises frame 100, support arms 110, braces 115, support arms 120, braces 125, gear mechanisms 130, actuator 140, and drive shaft 150.

Referring again to FIGS. 3A and 3B, expandable vehicle chassis 1000 comprises frame 100 and laterally opposed support arms 110 and 120. Support arms 110 and 120 are each movably attached to frame 100 such that each arm 110 and 120 is movable laterally relative to frame 100.

Referring still to FIGS. 3A and 3B, expandable vehicle chassis 1000 further comprises actuator 140. Actuator 140 is attached to one end of frame 100. Actuator 14 is further operably attached to drive shaft 150. Actuator 140 may be pneumatic, electric, gasoline powered, or hydraulic.

In the embodiment of FIG. 3B, frame 100 of expandable vehicle chassis 1000 further comprises drive shaft 150, which is attached to frame 100 and operably attached to drive shaft 150. As further shown in FIG. 3B, drive shaft 150 is disposed along the longitudinal axis of frame 100 or expandable vehicle chassis 1000.

Referring again to FIG. 3B, frame 100 of expandable vehicle chassis 1000 further comprises at least one gear mechanism 130. In one exemplary embodiment, frame 100 of expandable vehicle chassis 1000 includes a plurality of gear mechanisms 130 disposed along the longitudinal axis of frame 100.

Referring still to FIG. 3B, support arm 110 comprises horizontal braces 115, and support arm 120 comprises horizontal braces 125. In the embodiment of expandable chassis 1000 shown in FIG. 3B, support arms 110 and 120 are in mechanical communication with gear mechanism 130. When actuator 140 is activated, it engages drive shaft 150 which engages gear mechanisms 130. Lateral braces 115 and 125 of support arms 110 and 120, respectively are mechanically connected to gear mechanisms 130 such that support arms 110 and 120 are simultaneously moved in opposing lateral directions relative to frame 100 upon activation of actuator 140.

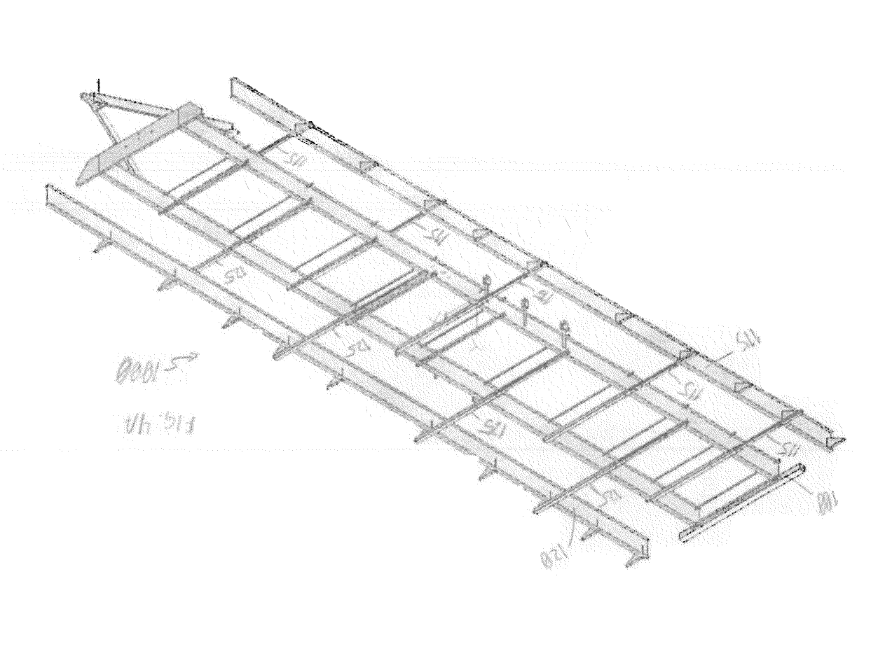

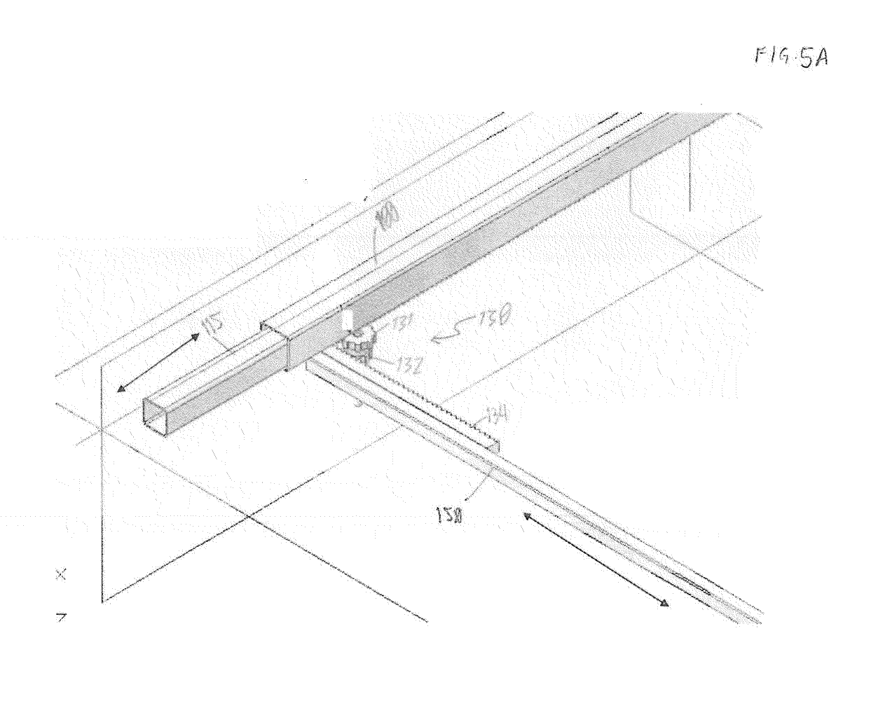

FIGS. 4A and 4B show expandable chassis 1000 in an open position. As shown in FIGS. 4A and 4B, lateral support arms 110 and 120 are mechanically connected to frame 100, but spaced apart laterally from frame 100 in opposing directions.

Refer now to FIG. 4A, where there is shown a top perspective view of expandable vehicle chassis 1000 in accordance with an embodiment of the present invention, with chassis 1000 in an open position and to FIG. 4B, where there is shown a top view of expandable vehicle chassis 1000 in accordance with an embodiment of the present invention, with chassis 1000 in an open position. Expandable vehicle chassis 1000 comprises frame 100, support arms 110, braces 115, support arms 120, braces 125, gear mechanisms 130, actuator 140, and drive shaft 150.

Referring again to FIGS. 4A and 4B, expandable vehicle chassis 1000 comprises frame 100 and laterally opposed support arms 110 and 120. Support arms 110 and 120 are each movably attached to frame 100 such that each arm 110 and 120 is movable laterally relative to frame 100.

Referring still to FIGS. 4A and 4B, expandable vehicle chassis 1000 further comprises actuator 140. Actuator 140 is attached to one end of frame 100. Actuator 140 is further operably attached to drive shaft 150. Actuator 140 may be pneumatic, electric, gasoline powered, or hydraulic.

In the embodiment of FIG. 4B, frame 100 of expandable vehicle chassis 1000 further comprises drive shaft 150, which is attached to frame 100 and operably attached to drive shaft 150. As further shown in FIG. 4B, drive shaft 150 is disposed along the longitudinal axis of frame 100 or expandable vehicle chassis 1000.

Referring again to FIG. 4B, frame 100 of expandable vehicle chassis 1000 further comprises at least one gear mechanism 130. In one exemplary embodiment, frame 100 of expandable vehicle chassis 1000 includes a plurality of gear mechanisms 130 disposed along the longitudinal axis of frame 100.

Referring still to FIG. 4B, support arm 110 comprises horizontal braces 115, and support arm 120 comprises horizontal braces 125. In the embodiment of expandable chassis 1000 shown in FIG. 4B, support arms 110 and 120 are in mechanical communication with gear mechanism 130. When actuator 140 is activated, it engages drive shaft 150 which engages gear mechanisms 130. Lateral braces 115 and 125 of support arms 110 and 120, respectively are mechanically connected to gear mechanisms 130 such that support arms 110 and 120 are simultaneously moved in opposing lateral directions relative to frame 100 upon activation of actuator 140.

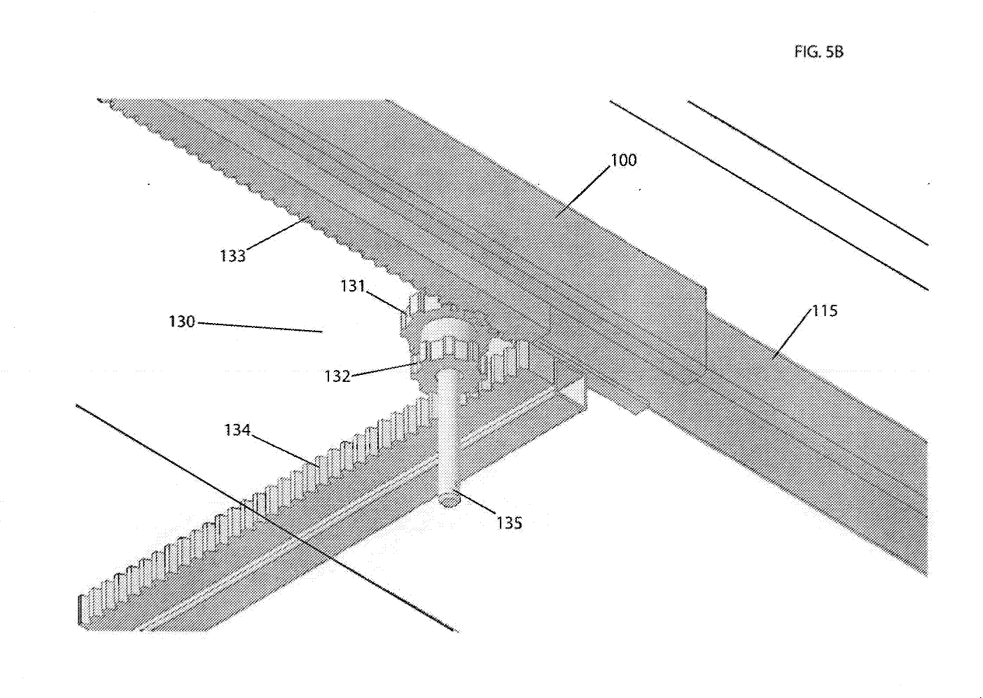

Referring now generally to FIGS. 5A and 5B, there is shown a detailed view of gear mechanism 130. FIG. 5A shows a top perspective view of gear mechanism 130, and FIG. 5B shows a bottom perspective view of gear mechanism 130. As illustrated in FIGS. 5A and 5B, gear mechanism 130 comprises top gear 131 and bottom gear 132 each of which is statically mounted to pin 135. Pin 135 is preferably rotationally mounted to frame 100 by known means.

Referring again to FIG. 5A, top gear 131 of gear mechanism 130 is preferably a different size, and preferably larger, than bottom gear 132 of gear mechanism 130. As illustrated in FIG. 5A, drive shaft 150 of expandable chassis 1000 comprises, in an exemplary embodiment, linear gear 134. Linear gear 134 of drive shaft 150 cooperates with round gear 132 such that as drive shaft 150 moves gear 132 rotates. As gear 132 rotates, so too does top gear 131 of gear mechanism 130.

As further illustrated in FIG. 5B, horizontal braces 115 comprises linear gears 133. (Although not shown, horizontal braces 120 also comprise similar linear gears.) When drive shaft 150 moves to cause bottom gear 132 to rotate, top gear 131 of gear mechanism 130 also rotates in the same angular direction. Top gear 131 cooperates with linear gear 133 such that arm 115 moves laterally relative to frame 100 of expandable chassis 1000.

It should be understood that the above description is of a preferred embodiment and included for illustrative purposes only, and it is not meant to be limiting of the invention. A person skilled in the art will understand that variations of this invention are included within the scope of the claims.

1. An expandable vehicle chassis, said chassis comprising:
a frame;
at least two opposing support arms movably attached to said frame;
a drive shaft attached to said frame and operably attached to each of said at least two opposing support arms;
an actuator mechanically attached to said drive shaft; and
a plurality of gear mechanisms generally disposed along an axis parallel to said drive shaft, said gear mechanisms operably attached to said drive shaft such that said actuator engages said drive shaft and said drive shaft engages said gear mechanisms to simultaneously move apart said at least two support arms in opposing directions.

2. The expandable vehicle chassis of claim 1, wherein said actuator comprises a motor selected from the group consisting of a hydraulic motor, a pneumatic motor, an electric motor, and a gasoline powered motor.

3. The expandable vehicle chassis of claim 1, wherein at least two pairs of opposing support arms are movably attached to said frame.

4. The expandable support chassis of claim 1, wherein the at least two opposing support arms move laterally relative to said frame.

5. The expandable support chassis of claim 1, wherein wheels are attached to the underside of said support arms.

6. An expandable vehicle chassis, said chassis comprising:
a frame;
two opposing support arms movably attached via a gear system to said frame; and
an actuator mechanically attached to a drive shaft, said drive shaft operably attached to said gear system such that said drive shaft engages the gear system to simultaneously move apart said opposing support arms in opposing directions.

7. The expandable vehicle chassis of claim 6, wherein said actuator comprises a motor selected from the group consisting of a hydraulic motor, a pneumatic motor, an electric motor, and a gasoline powered motor.

8. The expandable vehicle chassis of claim 6, wherein at least two pairs of opposing support arms are movably attached to said frame.

9. The expandable support chassis of claim 6, wherein the at least two opposing support arms move laterally relative to said frame.

10. The expandable support chassis of claim 6, wherein wheels are attached to the underside of said support arms.

11. An expandable vehicle chassis, said chassis comprising:
a frame;
at least two opposing support arms movably attached to said frame; and
means for moving said at least two support arms in opposing directions away from said frame, said means attached to said frame.

12. The expandable vehicle chassis of claim 11, wherein said actuator comprises a motor selected from the group consisting of a hydraulic motor, a pneumatic motor, an electric motor, and a gasoline powered motor.

13. The expandable vehicle chassis of claim 11, wherein at least two pairs of opposing support arms are movably attached to said frame.

14. The expandable support chassis of claim 11, wherein the at least two opposing support arms move laterally relative to said frame.

15. The expandable support chassis of claim 11, wherein wheels are attached to the underside of said support arms.
